(19) United States
(12) Patent Application Publication
(10) Pub. No.: US 2006/0288015 A1
(43) Pub. Date: Dec. 21, 2006

(54) Electronic content classification

(76) Inventors: Steven R. Schirripa, Hazlet, NJ (US); Masanori Harada, Mountain View, CA (US)

Correspondence Address: FISH & RICHARDSON P.C., PO BOX 1022, MINNEAPOLIS, MN, 55440-1022, US

(21) Appl. No.: 11/153,123

(22) Filed: Jun. 15, 2005

(51) Int. Cl. G06F 7/00

(52) U.S. Cl. 707/100

(57) ABSTRACT

A method for classifying electronic content is discussed. The method includes obtaining an electronic document from a computing system, identifying one or more document features of the electronic document, analyzing the identified document features to determine a format of electronic content contained in the electronic document (the determined format being implied by one or more indicators provided by the identified document features), and specifying whether the electronic content contained in the electronic document may be displayed on an identified type of computing device, based on the determined format.

### TECHNICAL FIELD

This application relates to electronic content classification in computing systems.

### BACKGROUND

As computers and computer networks become more and more capable of accessing information, people are demanding more ways to obtain that information. Specifically, people now expect to have access, on the road, in the home, or in the office, to information previously available only from a permanently connected personal computer hooked to an appropriately provisioned network. People may want stock quotes and weather reports from their cell phones, e-mail from their personal digital assistants (PDA's), up-to-date documents from their palm tops, and timely, accurate search results from all of their devices. People also may want all of this information when traveling, whether locally, domestically, or internationally, on an easy-to-use, mobile device.

Certain documents are not suitable for use on mobile devices. Mobile devices are not necessarily equal to their desktop counterparts. Users of mobile devices who want to see what they consider to be good, mobile content are often provided with content that is not practical, or even displayable, on their devices. In some instances, users may receive translated content provided by an intermediate source. For example, the intermediate source may translate web content from an HTML (Hypertext Markup Language) format to a WML (Wireless Markup Language) format and provide the translated content to a mobile device. Depending on the nature and/or quality of the translation process, the translated content may or may not be semantically equivalent to the original document, or the format may be still difficult to navigate on the mobile device.

Simplistic analysis of such documents may take the form of categorization of pages or documents by whether the page contains HTML tags that expressly state that a particular type of device is an appropriate device to display the page. Such analysis may also look to page size, suffixes for files on the pages, document type declarations, or such other straightforward content in a web page. For example, a doctype declaration is one in which an author of a web page is supposed to explicitly identify the type of markup language and standard.

Such simplistic approaches, though easy to carry out, have limits. They may, for example, make incorrect assumptions about a document since they are relying on explicit identifying information. For example, approaches that relate to searching for particular tags, such as for a doctype, may require close cooperation from the authors of the pages. The authors, however, may not properly code the document or otherwise follow the appropriate standard. Also, servers that provide explicit content identification for documents they serve can also be misconfigured and give out inaccurate data. Though such false responses may simply be aggravating in small numbers, they can undercut the legitimacy of a search engine when taken in total. As a result, there is a need for more flexible and sophisticated classification of electronic content for display on particular devices or classes of device.

### SUMMARY

Various implementations are provided herein. One implementation provides a method for classifying electronic content in a manner that relies at least in part on formats implied by document features, and is thus not dependent on the document's author having complied with particular conventions or rule. Such implicit features differ from explicit features, which are indication in a document whose primary purpose is to be an indication of the format of the document. Such explicit features include content type labels for a document, document type (doctype) tags, and the extensions for file names.

In one implementation, a method for classifying electronic content is described. The method comprises obtaining an electronic document from a computing system, identifying one or more document features of the electronic document, analyzing the identified document features to determine a format of electronic content contained in the electronic document (the determined format being implied by one or more indicators provided by the identified document features), and specifying whether the electronic content contained in the electronic document may be displayed on an identified type of computing device, based on the determined format. The specifying may include analyzing content-based document features, and the identified document features may be analyze by a machine learning system. In addition, the method may determine whether to insert an indexed entry associated with the electronic document into a searchable index based upon a level of confidence that the electronic content contained in the electronic document is displayable on the predetermined type of computing device, and the indexed entry may indicate the determined format of the electronic document.

In certain implementations of the method, the electronic content contained in the electronic document may comprise displayable web content. Also, at least one document feature of the electronic document may comprise a tagged feature that may be interpreted for display of electronic content on a computing device. In addition, the document analysis may comprise applying a predetermined ruleset to the identified document features, and the predetermined ruleset may apply one or more decisions to a plurality of document features. The specification of whether the content may be displayed may comprise applying one or more heuristic rules to the determined format and the identified document features, and may also comprise calculating a confidence rating that is based on a determined level of confidence that the electronic content contained in the electronic document is displayable on the predetermined type of computing device.

In other implementations of the method, the method may further comprise creating an indexed entry associated with the electronic document, the indexed entry indicating whether the electronic content contained in the electronic document may be displayed on the identified type of computing device, and inserting the indexed entry into a searchable index, the indexed entry being ranked within the searchable index. In addition, the identified type of computing device may comprise a computing device that is capable of displaying electronic content having one or more predetermined formats, and may in some circumstances comprise a wireless device or a predetermined brand or model of computing device. Moreover, the determined format may be selected from a group consisting of an XHTML (Extensible Hypertext Markup Language) format, an HTML (Hypertext Markup Language) format, a WML (Wireless Markup Language) format, and a cHTML (compact HTML) format.

In yet another implementation, a computer program product tangibly embodied in an information carrier is disclosed. The product includes instructions that, when executed, perform a method for classifying electronic content, where the method comprises obtaining an electronic document that is stored in a computing system, the electronic document having electronic content, parsing the electronic document and identifying one or more document features of the electronic document, analyzing the identified document features to determine a format of the electronic content contained in the electronic document (the determined format being based upon one or more indicators provided by the identified document features), and based upon the determined format and the identified document features, specifying whether the electronic content contained in the electronic document may be displayed on a predetermined type of computing device.

In another implementation a system for classifying electronic content is provided. The system may comprise means for receiving an electronic document, means for determining a format of electronic content contained in the electronic document, and means for specifying whether the electronic content contained in the electronic document may be displayed on a predetermined type of computing device based upon the determined format.

A method for classifying electronic content is provided in yet another implementation. The method may comprise obtaining an electronic document from a computing system, identifying a document type for the document using an explicit document type identifier associated with the document, analyzing one or more document features and the identified document type to determine a format of electronic content contained in the electronic document, the determined format being implied by one or more indicators provided by the identified document features, and based upon the determined format, specifying whether the electronic content contained in the electronic document may be displayed on an identified type of computing device.

In yet another implementation, another method is provided and comprises obtaining from a computing system an electronic document having electronic content, identifying a plurality of document features of the electronic document, calculating a document score based on the plurality of document features, and specifying whether the electronic content contained in the electronic document may be displayed on an identified type of computing device, based on the document score. The document features may comprise implied document features, and may also comprise content-based document features.

Various implementations may provide certain advantages. For example, a content classification module may automatically classify electronic documents into different mobile-related categories. This helps categorize, for example, web pages as being suitable or unsuitable for display on mobile devices. The content classification module is capable of assessing whether content contained within an individual document may be enabled for display purposes on a mobile device, as well as determining the specific devices (or device types) for which the content is most suited.

The details of one or more implementations are set forth in the drawings and the description below. Other features, objects, and advantages will be apparent from the description and drawings, and from the claims.

### DESCRIPTION OF DRAWINGS

FIG. 1A is a conceptual diagram showing components of a content classification system.

FIG. 1B is a block diagram of a system that may be used to classify electronic content, according to one implementation.

FIG. 1C is a diagram that shows the processing of electronic content within the system shown in FIG. 1B, according to one implementation.

FIG. 2A is a flow diagram of a method for classifying electronic content, according to one implementation.

FIG. 2B is a flow diagram of another method for classifying electronic content, according to one implementation.

FIG. 2C is a flow diagram of another method for classifying electronic content, according to one implementation.

FIG. 3A is a tabular diagram of entries associated with electronic content that may be stored within the index shown in FIG. 1B, according to one implementation.

FIG. 3B is a tabular diagram of entries associated with electronic content that may be stored within an index.

FIG. 4 is a screen diagram of a graphical user interface that may be provided to a user for searching electronic content within the system shown in FIG. 1B, according to one implementation.

FIG. 5 is a block diagram of a computing device that may be used within various of the components shown in FIG. 1B.

### DETAILED DESCRIPTION

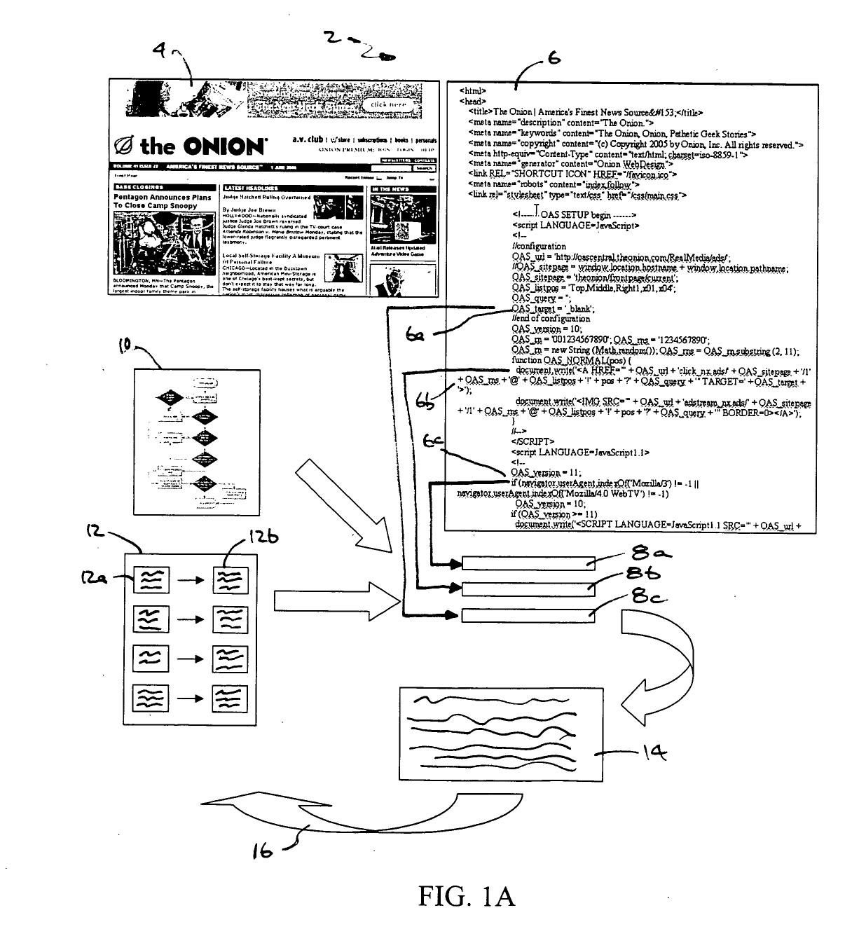

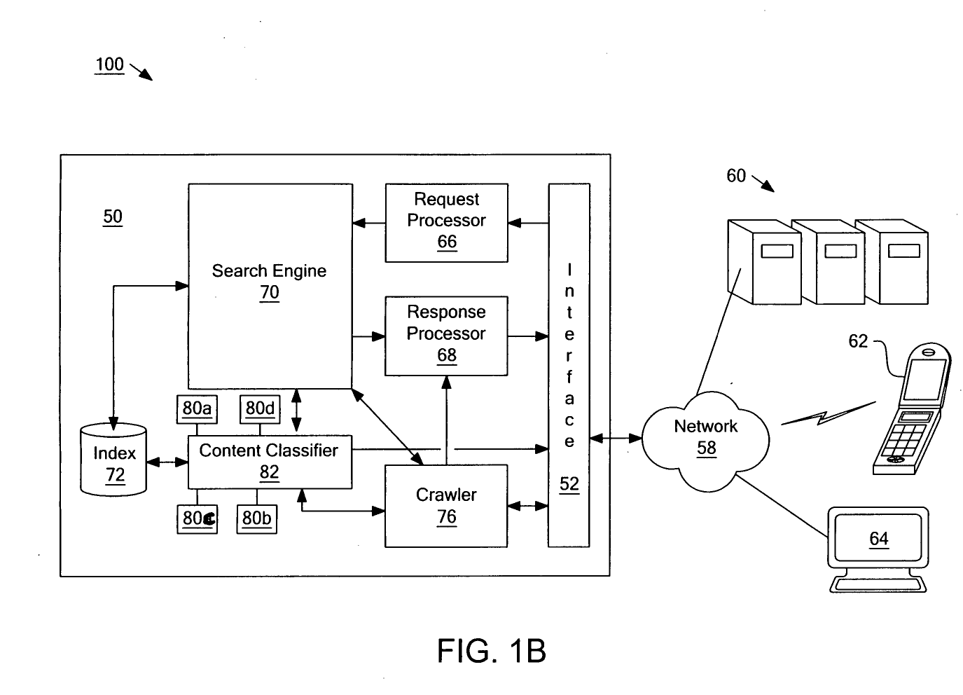

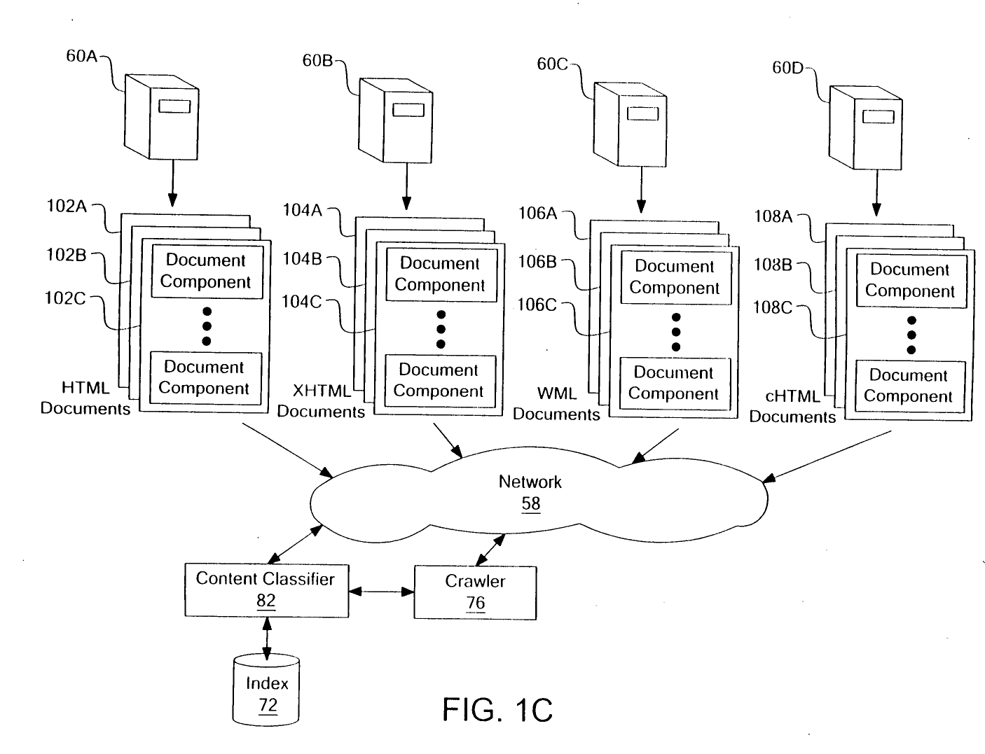

FIG. 1A is a conceptual diagram showing components of a content classification system 2. In general, the system 2 provides for the analysis of a displayed document 4 to ascertain whether, and to what extent, the document 4 may be displayed on particular devices, such as personal digital assistants and mobile telephones. The system may make inferences about the document 4 by a number of approaches that do not require any cooperation by the document's author. In particular, the system 2 can make conclusions by implication from the document 4, and there is no need for the document's author to have explicitly identified the type of the document 4 or the devices or class of devices on which the document 4 is meant to be displayed.

Two dimensions of document classification may be addressed by system 2. First, a determination of the format, or type, of electronic document 4 may be made. Second, the degree of usability and/or displayability of the electronic document 4 may be determined for particular devices, such as personal digital assistants (PDAs), desktop computers, or mobile phones. The degree of usability may be directed toward particular models of devices, potentially in combination with software executing on the device (e.g. a browser), or toward a class of devices (such as those with certain size screens). In the first dimension of document format, various features of the document may be extracted and considered in determining the document type. In the second dimension, the determined type of electronic document can be used as a factor in its technical feasibility of displaying on a particular device. The ability to display a particular document, however, might not imply its utility on that device. Hence, other factors may be considered in making a judgment of this second dimension of classification.

Also, a document that follows a standard and is technically displayable may not be usable on a particular device, and could be classified as lacking displayability as a result. For example, a document may be coded in XHTML Mobile and may technically display on a corresponding device because it matches the standard. But it nonetheless might not be usable, for example, if it is excessively wide. Thus, a system 2 may be provided that classifies such a document as not displayable even though it technically meets the standard and can be shown on the device or class of device, though with poor results and low usability. Such a document is not displayable because it would not be useful to a user on the device.

A feature of an electronic document is any property of the document, meta-information (including, e.g. HTTP headers or the uniform resource locator (URL) of the document), document contents and tags, and information implied by other documents and data sources (e.g. features of related or linked documents). Features can be combined into other compound features, which are themselves features, via Boolean constructions. For example, the presence of an <html> tag and the length of the document are two features. The presence of an <html> tag and length of the document at the same time can also be considered a feature.

A document may have both content-based features and non-content-based features. Content-based features relate to the actual content of a document, such as the presence of images, tables, particular language in the document, and information derived from these features (such as a total of the number of images in a document). Content-based features also include various tags in the document. Non-content-based features include other data and metadata about a document, such as the length of the document and the HTTP headers.

Features may also be explicit or implicit. An explicit feature is a feature whose primary purpose is to identify the type of document. Such explicit features include, for example, content type headers returned from web servers, a doctype declaration inside the document, certain other content-based features that explicitly identify the document type, and, in certain circumstances the extension of the electronic document filename. Explicitly identifying features do not necessarily suggest the correct file type. For example, web servers often blindly return a content type of text/html for documents that are not html, there is no requirement that an html document be named with a “.htm” or “.html” extension, and web browsers often display html correctly, even in the absence of a doctype declaration.

Implicit identifying features are features that are part of or related to the document that have some correlation to the file type, but which were not included to explicitly identify the type of document. They may include, for example, functional tags (<wml> and <html> tags, e.g., which are for standards compliance rather than identification). Another example is the accesskey tag attribute, which can be used for key shortcuts and may indicate more utility on mobile devices that are devoid of a pointing device, such as a mouse. Other implicit features may include the number of certain elements in a document, the type of elements (e.g., images, text, or active content), and the links from a document to other documents.

Associated with displayed document 4 is document source 6, which may simply be the text associated with the document or may be an underlying document in a format such as HTML or other mark-up language. The displayed document 4 and document source 6 could also be considered to be a single document—one rendered and one not rendered. In addition, multiple web pages may together be considered one document.

The document source 6 in this example is a text file containing a number of features, such as tags, according to a standard mark-up language. Some of the features may be unimportant to classification of the document, while others (features 6a, 6b, 6c) may be slightly relevant or very relevant. Thus, the document may be searched for the presence of particular relevant features. In addition, combinations of features or other patterns may also be identified.

For each identified feature or feature pattern in a document, one or more document features 8a, 8b, 8c, or document parameters may be extracted from or parsed out of the document source 6. For example, document feature 8a may be a particular file type to be displayed in the document, such as a jpeg image. Feature 8a may also represent all of the file types in the document as a composite. As another example, feature 8b may represent the degree of match between the document and a particular standard. For example, various portions of document source 6 may be reviewed and checked against a standard, with the document given a score correlating to the level of matchedness.

A document may be checked against a standard in yet another manner. For example, a lexer/parser that may be capable of parsing to multiple standards or loosely with respect to a standard or standard, may parse and interpret a document to a particular standard. As one example, it may be desirable to parse a document as loosely as is done by a commercial web browser, as document authors often create content that works in a browser, but is not necessarily compliant to a particular standard. In such a process, the document may be parsed iteratively, or in parallel, to each of multiple different standards until the parse is successful and the document can be interpreted in a particular format. The document may then be considered of the type or types in which it can be interpreted. After such a matching process, other features may be considered to further determine a classification for the document, such as by generating a composite score for the document.

As yet another example, feature 8c may represent structural components or features of the document 4. For example, if the document has certain numbers of images, active content such as Flash animations, tables, etc., feature 8c may show the quantity of each type of feature, and may also reflect the type or complexity of each feature. Thus, feature 8c may be considered when classifying the document as displayable or not displayable on a particular device, in that higher numbers of particular features or more complicated features would tend to indicate that a document is not displayable on particular device or class of devices. The various features may also include various mark-up tags, other meta data about the page such as page size and number of words, the web standards for the page (e.g., WML, HTML, XHTML, etc.) and variants on the standards (e.g., EZWeb XHTML).

In another example, different versions of a document, or features or components from different versions of the document, may be analyzed. For example, a web server may be configured to deliver a particular document in different manners. In such a situation, the system 2 may obtain the document in each form, and the various forms may be compared to derive information about the displayability of each. For example, where a document is stored in one form having a number of “rich” content features such as Flash animations and the like, and another form that is identical or substantially identical except for the additional rich content, the system may infer that the latter form was intended by the author for display on devices having limited display capabilities. These different versions could have been obtained, for example, by sending requests to the web server with different User-Agent and/or Accept headers, indicating different devices requesting the document.

Once appropriate features or parameters describing the document are extracted from or computed for a document, it may be classified for displayability in a number of manners, or by combining multiple techniques. In one classification method, particular classification rules 10 may be applied to the extracted features 8a, 8b, 8c. The rules 10, represented in the figure by a flowchart, can be a series of decisions, such as if/then decisions, applied to the features in a particular order in a manner that has been determined to provide a fairly accurate assessment of a document's displayability. The rules 10, may be, for example, a number of heuristics that have been combined so as to create a combined score or likelihood of the document 4 being displayable on a particular device. The rules may also involve analysis of individual features to generate scores for those features, followed by a combination of the scores in a weighted manner to generate a composite score for the document 4.

A document score may be produced from a number of different features that have been parsed from, extracted from, or formed from a document (e.g., by combining multiple parsed features). For example, the number of tables, number of images, number of words, or the document type may each alter the score (e.g., for each image the score is incremented or decremented by a certain amount, and may be changed a greater amount if the image is larger). Explicit features such as the document type may be given a higher weight in computing the score than are certain implicit features. Also, a presumptive classification may be applied based on explicit features (e.g., document type), on the assumption that the document author complied with appropriate standards, and implicit features may be evaluated to create a score that will overcome the presumption if the score is sufficient high or low.

Patterns may also be applied to classify a document, such as by a predetermined set, or order, of patterns. The patterns may be used to match identified document features, along with potential orders or sequences of features, against baseline patterns. These patterns can be associated with predetermined content formats (e.g., XHTML, HTML, WML, cHTML). The parsed output of the document may be matched against tokens in one or more of these patterns in attempting to determine the format of the content contained in the document. There may be multiple different baseline patterns that are associated with one predetermined content format. As one example, a pattern may be used by a content classifier to match document features against known data-type definitions for a given document type. One exemplary pattern may specify common mobile tags (e.g., href:tel “click to call” tags), and another exemplary pattern may specify certain Japanese encodings and characters.

In one example, the rules can be generated via a machine learning algorithm. In such an approach, initial rules may be supplied. A pre-labeled corpus of documents may be provided by manually classifying a number of documents. The algorithm may result in the creation of a new set of rules for classification that would, for example, provide a small or the smallest error in determining classifications of the documents in the initial corpus of documents. The algorithm may work, for example, on the extracted features of the documents in this training set. Subsequent documents may be analyzed and the rules applied to them to classify them. Where various features are extracted and analyzed so as to produce a composite score for a document, the system may adjust each of the scores, features to consider, weights to give, and any other appropriate factor. Any applicable approach for machine learning may be used to improve the rules or algorithms for classifying documents using synthesized data, including connectionist nets, decision trees, neural networks, Bayesian learning, instance-based learning, and genetic algorithms.

As part of the machine learning or other appropriate process, results of the classification, such as in the form of aggregated features 14 can be fed back into the heuristics used for making the classification, as shown by arrow 16. The aggregated features 14 may simply be a formatted combination of the extracted features 8a-8c, or may take any other appropriate form, such as a set of predetermined features into which values representative of the document 4 are placed. Other techniques may also be employed. For example, added documents may be sampled from time to time and documents that display particularly well or particularly poorly on a device or devices, as determined manually or electronically, can be identified and the features that led to a proper or improper classification of those documents may be given greater or lesser importance, or values for the features may be given different weights, for later classification of documents. Also, new heuristics may be added over time, particularly as standards or usage patterns evolve.

A module 12 for classifying to a norm may also be provided. In this implementation, the norm may be represented by a number of normative documents 12a, or features from normative documents. A normative document is simply one selected to be in a group of normative documents or that includes a profile of features that is representative of a particular form of document. Each normative document may have associated with it a device list 12b, which may correspond to the devices or classes of devices (e.g., types of devices) for which the document is displayable. The normative documents 12a may include, for example, a pre-selected test suite of documents that have been selected to represent a range of document styles having a variety of distinct features or values for features.

Aggregated features 14 of a document to be displayed may then be compared to features for each normative document, with scores assigned for the level of match between corresponding features in the normative documents 12a and the aggregated features 14. For the normative document 12a with the highest score or for documents with a score that is sufficiently high (e.g., when there are multiple devices for a single document), the device list associated with the particular normative document 12a may then become associated, either directly or indirectly, with the particular document 6. In this manner, when a device makes a request for the document, the type of the device may be checked against the devicelist to determine if the document is displayable.

In addition, a set of documents may be established, either as part of or apart from a training set of documents. Changes may then be made to the classification system (e.g., by changing the classification rules), and the changed system may be applied to these documents. The results of such an application may be compared to standard results believed to provide appropriate classification, so that the appropriateness of the changes made to the system may be determined.

The features may be used both in determining the format or type of the document, and in determining its displayability. For example, certain features may be extracted and considered in determining the document type—such as by looking to a level of match with a recognized standard such as WML 1.2. If all portions of the document match the standard, it may be given full credit as matching the standard, while if a few portions lack a match, it may be given partial credit (i.e., a lower score). The document type may then be used as one of multiple factors in determining whether a document is displayable, such as by giving it and other features a weighted score.

Whether the documents were truly displayable or not may then be tested, such as by providing them to a particular device or a machine programmed to emulate a particular device, and then determining whether the document displayed satisfactorily. Such a determination could be made automatically or manually, such as by having a user indicate whether the display was or was not adequate. Successful display can result in the system re-confirming the rules used to classify the document, including for example, by weighting those rules more heavily for future classifications. Unsuccessful display can result in demotion of the relevant rules in importance for future classification.

The techniques and features just discussed in concept may be implemented in any appropriate environment where proper display of documents is a concern, including in the systems and methods discussed below.

FIG. 1B is a block diagram of a system 100 that may be used to classify electronic content, according to one implementation. In this implementation, the system 100 includes a data processing system 50, a network 58, servers 60, a handheld mobile (wireless) device 62, and a client computer 64. The data processing system 50, the servers 60, the mobile device 62, and the client computer 64 are each coupled to the network 58. The mobile device 62 communicates wirelessly with the network 58. The network 58 may comprise a LAN (local area network) or a WAN (wide area network), such as the Internet. The data processing system 50 is capable of indexing electronic content that is stored on the servers 60, determining the format of this content based on content indicators, and specifying whether the content is compatible for display purposes on the client computer 64 or the mobile device 62.

The servers 60 in the system 100 each may contain a wide assortment of electronic content. For example, one of the servers may store electronic news content, while another one of the servers may store electronic stock or game content. The servers 60 may also store electronic content in a variety of different content formats. For example, the servers 60 may store electronic content in electronic documents that are written in XHTML (Extensible Hypertext Markup Language), HTML (Hypertext Markup Language), WML (Wireless Markup Language), cHTML (compact HTML), or in a language that uses another format. Computing devices, such as the mobile device 62 or the client computer 64, may process these electronic documents to display the corresponding electronic content on a display device. For example, the mobile device 62 may be capable of interpreting electronic documents written in WML or XHTML if the mobile device includes a browser that complies with the WAP (Wireless Application Protocol) standard. Once the mobile device 62 interprets the documents of these formats, the mobile device 62 is capable of displaying the corresponding electronic content (e.g., news or stock information) on its display device. The client computer 64 may be capable of interpreting electronic documents written in XHTML or HTML and displaying the corresponding content on its display device.

The data processing system 50 is provided with an interface 52 to allow communications in a variety of ways. For example, the data processing system 50 may communicate with the servers 60 via the network 58 to process electronic content that is stored on these servers 60. The data processing system 50 includes a crawler 76, a content classifier 82, and a searchable index 72. The crawler 76 automatically traverses the network 58 and requests electronic documents from the servers 60. In one implementation, the crawler 76 accesses these documents from the servers 60 using the URL's (Uniform Resource Locators) of the servers 60. The crawler 76 may use an initial set of URL's and retrieve referenced documents from the servers 60 pointed to by these URL's. The crawler 76 typically keeps track of the URL's it has previously visited. Each time the crawler 76 identifies a new electronic document that is stored on one of the servers 60, it retrieves the document and passes it to the content classifier 82.

The content classifier 82 then classifies the electronic content of the document, as is described in more detail above and below. For example, the content classifier 82 may determine that the electronic document is written in WML, and that its content can be displayed on the mobile device 62. (The mobile device 62 shown in FIG. 1A comprises a cellular telephone handset, but could take any appropriate form, such as a personal digital assistant, a voice-driven personal communication device, or any other form of mobile device.)

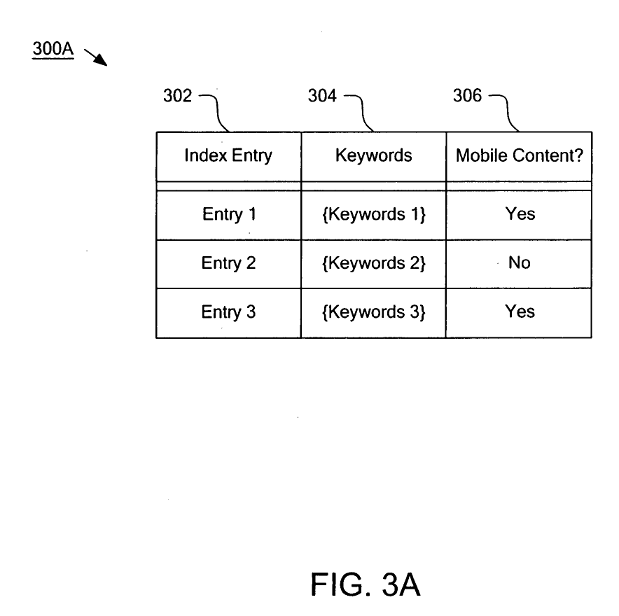

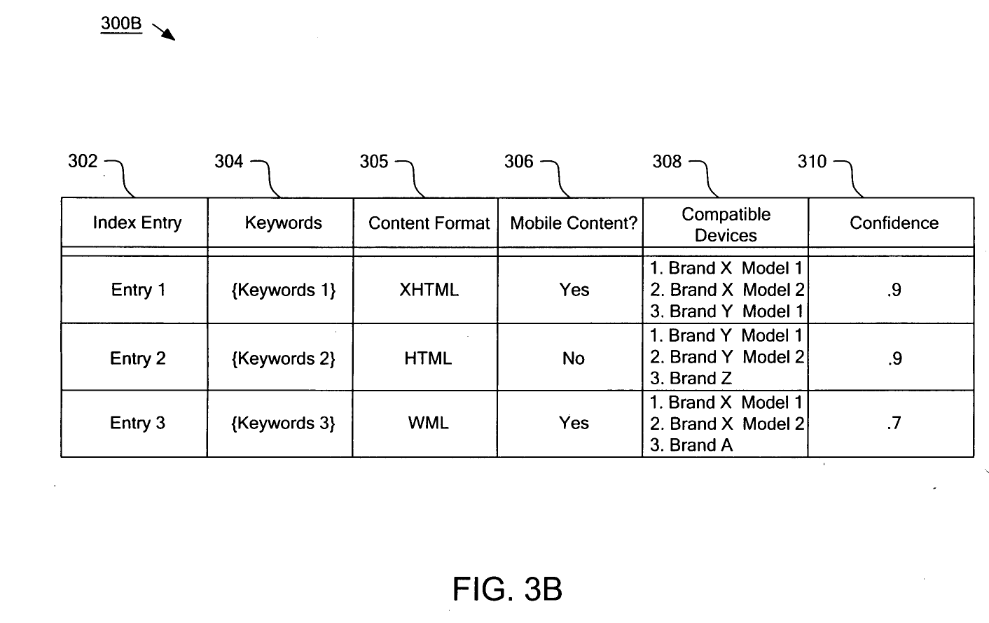

In one implementation, the content classifier 82 determines that an indexed entry associated with the electronic document should be inserted in the index 72 if a predetermined condition is satisfied. For example, the content classifier 82 may determine that an entry should be inserted if the content of the electronic document can be displayed on a mobile device, such as the mobile device 62, if the index 72 contains entries corresponding to mobile content in general. Examples of entries that can be inserted into the index 72 are shown in FIGS. 3A and 3B.

The content classifier 82 may further determine if the crawler 76 should continue to follow any address links that are contained within an individual electronic document. For example, if the electronic document is written in XHTML, it may contain tags that provide addresses, or embedded URL's, for other electronic documents that are stored on the servers 60. If the content classifier 82 is classifying mobile content, it may determine that the crawler 76 should continue to crawl and follow any address links contained in an electronic document if the content classifier 82 has determined that the electronic document contains mobile content that can be displayed on a mobile device (such as the mobile device 62). In this case, the links in the document may point to additional documents having mobile content. If, however, the content classifier 82 determines that the electronic document does not contain mobile content, it may indicate that the crawler 76 should not follow the address links. In another implementation, the content classifier 82 is not used during the crawl, and is instead used after the crawl is completed to determine the documents that should be added to index 72.

In one implementation, the content classifier 82 may decide not to insert an entry for an electronic document into the index 72, but still request that the crawler 76 follow the links pointing to other electronic documents stored on the servers 60. For example, the content classifier 82 may determine, with a confidence level of 60%, that the electronic document is an XHTML document having mobile content. In this example, the content classifier 82 may decide that an entry for this document should not be included within the index 72 because the confidence level is below a first preconfigured threshold (e.g., 75%). The content classifier 82 may only want to insert entries into the index 72 if it is at least 75% certain that the corresponding documents contain mobile content that can be displayed on a mobile device. However, the content classifier 82 may decide that the crawler 76 should follow any links contained in the document if the confidence level is above a second preconfigured threshold (e.g., 50%). The first preconfigured threshold and the second preconfigured threshold may have different values.

The content classifier may also be implemented as a modular sub-system. In such a sub-system, a central content classifier 82 is provided and includes the necessary functionality for identifying, interacting with, and parsing documents. Individual classification modules 80a, 80b, 80c, and 80d may also be provided as plug-ins to the content classifier 82. Each module may provide particular rules, such as heuristic rules, for a particular type of document content. For example, module 80a may contain rules that operate on a number of document features that are separately identified by content classifier 82, and may generate a displayability parameter for a document based on those features. Likewise, module 80b may contain rules that look to particular structural features of a document, such as boilerplate and tables, and may generate a parameter about the displayability of the document. The parameters may then be passed to the content classifier 82 in a predetermined format so that the document may be passed or not passed to a particular device. Content classifier 82 may be implemented to have a standard application programming interface (API) which programmers may follow in creating additional classification modules.

Modules for the system in the form of plug-ins may perform a variety of tasks. For example, a plug-in could extract document features, while another may analyze the extracted features to determine if the document is in a particular format (e.g., one plug-in for WML, and another for XHTML). Also, a separate module may be provided for each device or class of devices, to determine the displayability for the device. Each plug-in may also have a separate API. For example, to add a new feature, a developer may add a FeaturePlugin, when they want to recognize a new standard, they may implement a FormatPlugin, and when they want to determine the usability for a new device, they may implement a DevicePlugin.

The information generated by identifying and processing various document features may be stored in any appropriate format. For example, an extensible structured format such as XML may be used.

Once electronic content from the servers 60 has been indexed within the index 72, the mobile device 62 and the client computer 64 may send search requests to the data processing system 50. These search requests are processed by the request processor 66. The requests may include one or more keywords. For example, if a user of the mobile device 62 wants to search for web pages relating to dogs, the user may submit a search request that includes the keyword “dog”. Requests other than search queries may also be received, and various modes of providing requests may be employed. For example, voice input and other appropriate forms of input may be handled.

In one implementation, the mobile device 62 and the client computer 64 may also provide additional information to the data processing system 50, such as device identification information or display capability information. This additional information may be used by the data processing system 50 when processing search requests sent by the mobile device 62 or the client computer 64. For example, the mobile device 62 may provide additional information to the data processing system 50 specifying that the mobile device 62 is a “Brand X Model 1” with browser Z device that is capable of displaying electronic content contained in XHTML or WML documents. This information may be provided to the data processing system 50 when the mobile device 62 first connects to the data processing system 50 through the network 58.

The request processor 66 processes incoming search requests and provides them to the search engine 70. The search engine 70 then accesses the index 72 to search for matching entries. The search engine 70 uses information contained in the search requests (such as search terms) to locate matching entries. The search engine 70 may also use any additional information that has been provided by the request initiators when locating matching entries. For example, if the mobile device 62 has provided additional information specifying that it is a mobile device capable of displaying electronic content contained in XHTML or WML documents, then the search engine 70 can filter out entries in the index 72 that are associated with document content having different formats. The search engine 70 may further rank retrieved entries, or search results, according to criteria specified in search requests, by the additional information provided by the request initiators, or by confidence level, for example.

The search engine 70 provides the search results to the response processor 68. The response processor 68 formats the results and creates response messages that are sent back to the request initiators (such as the mobile device 62 or the client computer 64). The request initiators may then analyze or display the search results to a user. The user may select one or more of these results to retrieve the corresponding electronic documents from the servers 60 and display their electronic content to the user.

FIG. 1C is a diagram that shows the processing of electronic content within the system 100 shown in FIG. 1B, according to one implementation. In the example shown in FIG. 1C, the system 100 includes four servers 60A, 60B, 60C, and 60D. Each of these servers 60A-D store various electronic documents having electronic content. The crawler 76 is capable of downloading one or more of these electronic documents across the network 58. The content classifier 82 is then able to classify the content contained within these electronic documents.

Each of the servers 60A-D store electronic documents having content of various formats. For example, as shown in FIG. 1C, the server 60A stores HTML documents, such as the documents 102A-C. The server 60B stores XHTML documents, such as the documents 104A-C. The server 60C stores WML documents, such as the documents 106A-C. The server 60D stores cHTML documents, such as the documents 108A-C. In one implementation, any of the given servers 60A-D is capable of storing electronic content of multiple different formats. For example, the server 60B may store both XHTML and WML documents.

Each of the documents 102A-C, 104A-C, 106A-C, and 108A-C includes one or more document features. For example, the HTML document 102C may contain various different document features for different HTML tags that are included within the document. These features are used to determine how to display electronic content contained within the document, according to one implementation. Certain document features may include address link information. For example, certain HTML tags may provide information about URL (uniform resource locator) links to other documents stored on separate servers. The crawler 76 may follow these links when searching for content stored in multiple different documents.

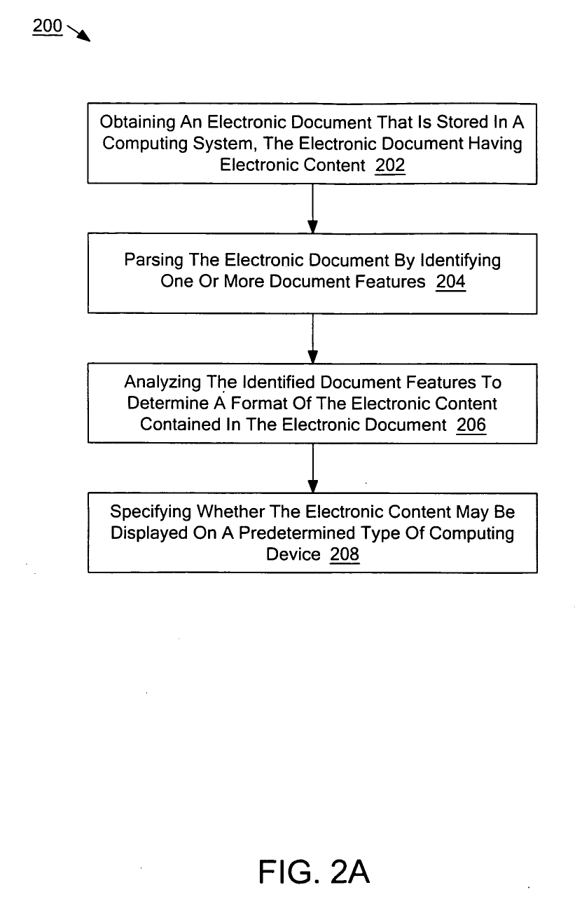

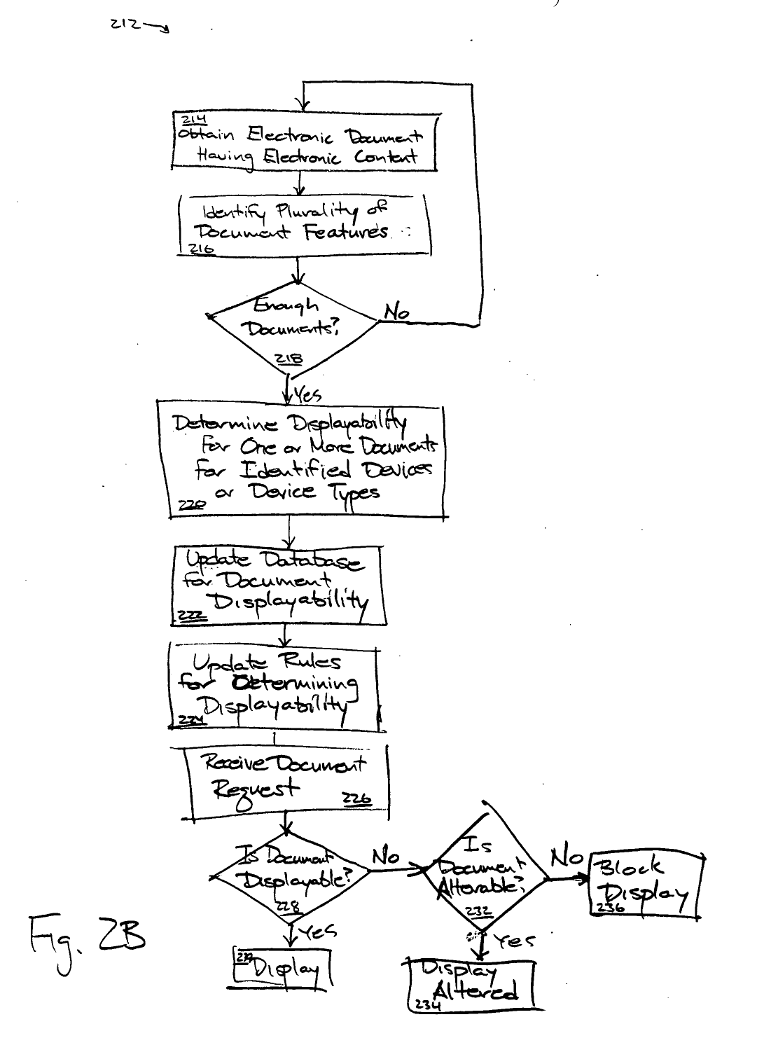

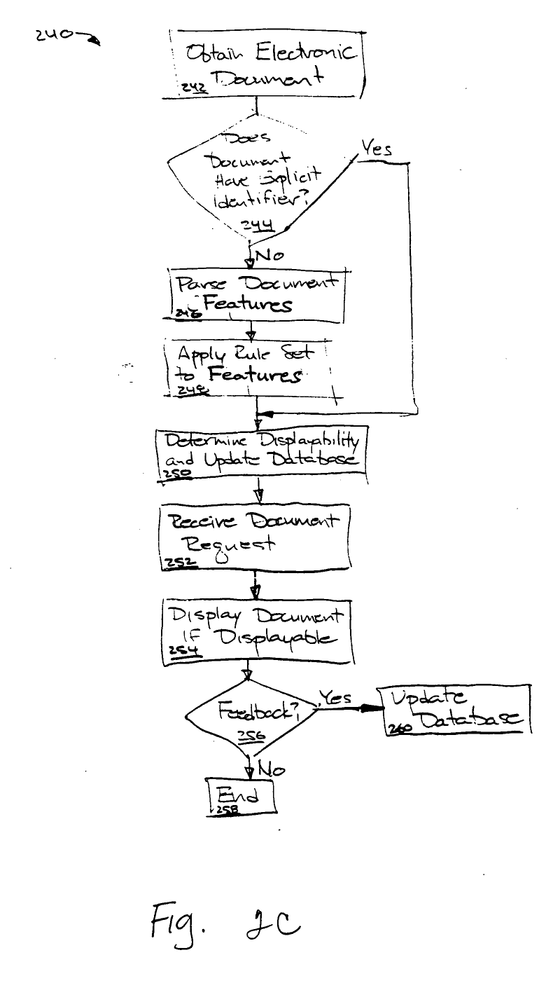

FIG. 2A is a flow diagram of a method 200 for classifying electronic content, according to one implementation. The flow diagram of FIG. 2A may employ the system shown in FIG. 1C, as now described. The uses of the system shown in FIG. 1C is merely illustrative, however, and any appropriate system may be used.

The method 200 includes acts 202, 204, 206, and 208. In the act 202, the crawler 76 obtains an electronic document from a computing system, such as one of the servers 60A-D. The crawler 76 provides the document to the content classifier 82. In the act 204, the content classifier 82 parses the electronic document and identifies one or more of the document features contained within the document. Several different parsing mechanisms may be used. In one implementation, the content classifier 82 uses a parser framework to achieve multiple potential parses with a single iteration over the document. In this implementation, the parser is capable of identifying document features of various different formats, such as XHTML, HTML, cHTML, or WML, in a single pass. The identified features may include specific document tags, such as HTML-type tags.

In another implementation, a generic parser framework may be used that manages separate parsers that are capable of parsing documents of specific formats. For example, the generic parser framework may make an estimation of the format of an electronic document. The framework may use content types, file extensions, and file names to make estimations. In one implementation, the framework may identify a number of different, individual parsers (e.g., a WML parser and a XHTML parser) that may potentially be used to parse a document. For example, the framework may determine that a given electronic document is either an XHTML or a WML document. Based on the file extension/file name/etc. of the document, the framework may estimate that the document is more likely to be an XHTML document. In this case, the framework may invoke an XHTML parser. If the XHTML parser is not capable of adequately parsing the document, or if it believes that another parser would be more successful, it can notify the framework. At this point, the framework may invoke the WML parser. In this fashion, the framework is capable of invoking parsers in some predetermined order.

In the act 206, the content classifier 82 analyzes the identified document features of a given electronic document to determine a format (e.g., XHTML, HTML, WML, cHTML, with perhaps even a standard version such as WML 1.2) of the electronic content contained in the document.

The content may also be analyzed by many other methods. For example, machine learning may be used to analyze a plurality of documents, so that decisions made with respect to certain documents may improve decisions for later documents.

Also, heuristic rules for document classification may also be developed through the analysis of multiple documents, as discussed in more detail above.

In the act 208, the content classifier 82 specifies whether the electronic content contained in a given document may be displayed on a predetermined type of computing device (such as a mobile device in general, and/or a specific brand or model of device). The content classifier 82 may use one or more heuristic rules applied to extracted features to attempt to determine whether the content of the document may be displayed on the predetermined type of computing device. Some sample heuristics may include using document size, number and size of images included within a document, number of tables in the document and table properties, and use of legal/illegal tags.

The content classifier 82 may use these heuristic rules to determine if the document includes mobile content, according to one implementation. These rules may specify, for example, that the repeated existence of specified tags within the document indicate, with a higher degree of confidence, that the document contains mobile content that can be displayed on a mobile device in general (or that can be displayed on specific brands/models of devices as well, according to some implementations). The content classifier 82 may track the number of features within the document (e.g., links, images, tables, tag types, etc.) and use the heuristic rules to make a determination as to type of devices that may display the document content. In addition, the content classifier may look to use or non-use of stylesheets, or to use or non-use of Flash, applets, and scripting.

In one implementation, the content classifier 82 calculates a confidence rating when making a determination of the types of computing devices (e.g., mobile devices) on which electronic content may be displayed. For example, the content classifier 82 may use patterns and/or heuristics rules to determine that, with an 80% confidence, a given document contains mobile content (such as WML content) that may be displayed on a mobile device. The content classifier 82 may then assign a confidence rating of 0.8 to an entry associated with this document (wherein the entry may also be stored within the index 72 shown in FIG. 1B). The confidence rating may also relate to specific brands/models of mobile devices. For example, the content classifier 82 may determine that, with an 80% confidence, a given document contains content that may be displayed on a “Brand X Model 1” type of mobile device, perhaps with the browser version included.

FIG. 2B is a flow diagram 212 of another method for classifying electronic content, according to one implementation. In this process, various documents are identified, such as by the techniques described above, and the displayability of the documents are inferred by analyzing a number of document features. At act 214, an electronic document having electronic content is obtained, and at act 216, a plurality of features for the document are identified. The features may include features such as the document type, document size, types of objects in the document (images, tables, boilerplate, etc.), whether the document is a variant of a particular format (e.g., EZWEB XHTML), and other features discussed above.

At act 218, a determination is made if enough documents have been obtained. It may be necessary only to obtain a single document at a time and then classify the document. It might also be necessary to obtain a starting corpus of documents, establish a base set of rules, and then obtain additional documents and applies the rules to the documents (and perhaps adjust the rules based on experience in classifying documents using the earlier rules). The later collection and classification of documents may then occur on a rolling basis, such as when the documents are identified and retrieved by a crawler. The processing of documents may also occur in a batch fashion.

In the remaining acts, the classification rules are updated and the document is displayed if such display is plausible. At act 220, the displayability of one or more documents is determined for one or more devices or types of devices. Such a determination may include, for example, an initial determination of the document type based on various features of the document, as discussed in more detail above. It may then include a determination of displayability that considers the determined document type along with other factors. When the displayability of the document is determined, a database may be updated in a manner relating to the document, as shown in act 222 (e.g., so that the displayability may be readily determine if a request for the document is received from a particular device or type of device). The rules for determining displayability may also be updated (act 224), such as by machine learning techniques described above.

At some time, a request for a document may be received, as at act 226. If the document has already been located and processed, its ability to be displayed on the requesting device may be determined by checking the database. If the document has not yet been processed, it may be processed as just described to provide a determination of displayability, such as a compound score. If the document is displayable, as determined at act 228, it may be displayed (such as by transmitting the document or a link relating to the document) to a remote device. If the document is not displayable in its native form, the system may determine whether the document may be altered in some way and still achieve adequate displayability, as shown at act 232. For example, particular features that prevent displayability may be removed from the document before it is transmitted. If the document can be displayed in altered form, it is displayed (act 234) and if it is not, its display is blocked (act 236). For example, where the document cannot be displayed even in altered form, a link to the document could be blocked or could be transmitted but in a manner that is displayed on a remote device to indicate its inability to be displayed (e.g., in a special contrasting color). Where alteration is required for there to be adequate display of a document, a system may be enabled to locate particular features such as tags, by which an author may indicate a desire that the document be displayed only in unaltered form.

Thus, by this process a number of documents are gathered and classified according to their features. Later documents are obtained or gathered and are classified according to classification rules generated from the initial corpus of documents or according to rules generated based on further experience classifying documents. Each identified feature may then play a role in allowing a system to make an educated assumption about the displayability of the document.

FIG. 2C is a flow diagram 240 of another method for classifying electronic content, according to one implementation. In this method, classification of an analyzed document involves both explicit and implicit classification, and also allows follow-up changes to be made to the classification of a document. At act 242, an electronic document is obtained, such as by the features discussed above. At act 244, the system checks the document to determine whether it contains any explicit identifiers. For example, the document may contain an HTML or other mark-up tag, such as a WML content type header and a WML doctype declaration. If the document has an explicit identifier, the process may move forward, as there is no need to infer the document type. Of course, inference of the document type may also be employed as a check on any explicit document identifier.

If there is no explicit document identifier, the process at act 246 parses the document features. Of course, the parsing may have occurred as part of the process of determining whether there was an explicit identifier also. With the relevant features obtained from the document, one or more rule sets may be applied to one or more of the features, as in act 248. For example, the document may first be checked to determine the document format, and then to determine the document's displayability on a device or class of devices. For a determination of displayability, for example, the system may look at the document as having a XHTML Basic profile, with no tables or images, a small page size, and the presence of accesskey numeric shortcuts (i.e., that permit simpler operation using the limited keypad of a mobile telephones).

If the document contains an explicit identifier or rule sets have been applied to infer the type of document, the displayability of the document may be determined, and the database updated regarding the document's ability to be displayed on particular devices or classes of devices (act 250). Particular features of the document may also be recorded so that the displayability of the device may be determined easily when a device on which the document is to be displayed has been identified. By classifying documents according to device class or by classifying after a request for the document, a system may enable the classification of documents even for devices that have not yet been developed.

At some later time, including after many documents have been classified, a document request may be received, at act 252. Alternatively, a document may be classified after the request is received, for example in a real-time classification system or where the particular document simply has not previously been located by the system. At act 254, the system uses information it has received from the request to determine the device on which the request was made, and checks the relevant information for the document to determine if the document is displayable, whether in raw form or in a modified form.

If the document is displayable, it is displayed. If it is not displayable, the system may send a message indicating that the document is not displayable or may simply decline to deliver the document or an indicator about the document-effectively blocking display of the document. For example, where a user presents a search request, the displayability of each search result may be checked. If a document is not displayable, its existence may not be shown to the user at all. Alternatively, information about the document (e.g., title, snippet, and URL) may be displayed to the user, but in a manner that indicates that the document is not displayable on the device (e.g., by shadowing, color, or extra text). In this manner, the user will be informed that the device may not display the document accurately, but may nonetheless choose to retrieve the document if it looks very relevant. The user may then get to see the document displayed as well as it can be displayed. The system may also provide a way for the user to view a modified version of the document that is deliberately altered in order to make it displayable on that device.

The system may also receive feedback about the document at act 256. The feedback may be used to reclassify the displayability of the document. For example, the user may be presented with an icon to identify whether the document displayed properly, and the user's choice may be aggregated with choices of other users regarding a document to reach an inference about the document's displayability. The displayability may be inferred also, such as by monitoring the amount of time between the display of the document and a user's moving out of the document. If the many user spend very little time in the document, it can be inferred that the document did not display properly or is not very useful. In either event, the document may be demoted in importance because it has not proven to be useful to users.

FIG. 3A is a tabular diagram of entries associated with electronic content that may be stored within the index 72 shown in FIG. 1B, according to one implementation. The index 72 may take any appropriate form, as is needed for a particular implementation. FIG. 3A shows a portion of information 300A that may be included within the index 72 for these entries. The content classifier 82 is capable of storing and/or sorting this information 300A in the index 72 when classifying content contained in documents that are stored on the servers 60. The search engine 70 is also capable of searching the information 300A in the index 72 when processing search requests sent from the mobile device 62 or the client computer 64 and obtaining search results.

The information 300A shown in FIG. 3A is organized into three columns 302, 304, and 306. The column 302 includes identification information for the indexed entries. FIG. 3A shows an example of three entries, named “entry 1”, “entry 2”, and “entry 3”. Each of these entries is associated with a particular electronic document that is stored on one of the external servers 60. The entry information in the column 302 may also contain other information about each corresponding entry, including meta information regarding the associated electronic content.

The column 304 contains various keywords associated with the corresponding entry and electronic document that is stored on one or more of the servers 60. These keywords are inserted into the index 72 during the content classification process. The keywords relate to the electronic content that is contained with the electronic documents whose entries are included within the index 72.

The column 306 indicates whether the corresponding entry is associated with an electronic document containing mobile content that is capable of being displayed on a mobile device, such as the mobile device 62. As described above, the content classifier 82 is capable of making a determination as to whether a given electronic document stored on one of the servers 60 likely includes mobile content. In one implementation, the content classifier 82 specifies that an electronic document includes mobile content if it is able to determine, with a certain amount of confidence, that the document includes mobile content. As is shown in FIG. 3B, the content classifier 82 may also specify a specific confidence level that is included within the index 72.

When the search engine 70 processes search requests, it can use the information provided in the column 306 when searching for matching entries. If the search engine 70 has received a search request from a mobile device, such as the mobile device 62, it may filter through entries in the index 72 by looking for those entries that satisfy the search request and that are associated with documents having mobile content, as specified by the information contained in the column 306.

In one implementation, the entries in FIG. 3A also includes document location information (such as URL location information). The location information may be included in a separate column for each indexed entry, and may specify the location at which the corresponding electronic document is located on one of the servers 60. The search engine 70 can then provide the location information for each entry that is included within the set of search results that are passed back to the mobile device 62 or the client computer 64.

FIG. 3B is a tabular diagram of entries associated with electronic content that may be stored within an. FIG. 3B shows a portion of information 300B that may be included within the index 72 for these entries. The information 300B includes information from the columns 302, 304, and 306 (as was included within the information 300A shown in FIG. 3A). Additional information is included within the columns 305, 308, and 310. The column 305 indicates the format of the electronic content contained within the document that is associated with the given indexed entry. The content classifier 82 is capable of making a determination of the content formats for electronic documents during the classification process. Examples of content formats may include an XHTML format, an HTML format, a WML format, or a cHTML format. The search engine 70 is capable of identifying search results by using information contained within the column 305. When the search engine 70 receives a request from a request initiator, such as the mobile device 62, it can make a determination as to the content formats that are supported by the initiator. It may do so based on previously received information from the initiator that specifies those formats that are supported, or it may use preconfigured information. The search engine 70 may then use the information contained in the column 305 to identify matching entries. For example, if the mobile device 62 only supports WML content, the search engine 70 can identify those entries that are associated with documents having WML content.

The column 308 includes information about the devices that are compatible with the content formats listed in the column 305. As shown in FIG. 3B, the column 308 may include brand and model information for the compatible devices. In one implementation, the column 308 may include information about every device known by the content classifier 82 to be compatible with the content formats listed in the column 305. The information about compatible devices may be preconfigured. When the search engine 70 processes search requests, it may have access to information about the specific device (such as the mobile device 62) that has made the request. In one scenario, the search engine 70 may obtain search results based only upon the information provided in columns 305 and/or 306. However, in another scenario, the search engine 70 may choose to use the information contained in the column 308 to identify only those matching entries (search results) that are pertinent to the specific device that has initiated the request. For example, the mobile device 62 may be a “Model 1” device for “Brand X”. If the search engine 70 has access to this information, it may choose to use the information contained in the column 308 to identify those entries for documents having mobile content compatible with devices for “Model 1” of “Brand X”, and perhaps the browser and its particular version.

The column 310 includes a confidence rating. In the example of FIG. 3B, the confidence ratting may be a number between “0.0” (meaning 0% confidence) and “1.0” (meaning 100% confidence). The content classifier 82 specifies a confidence with which it is able to determine the content format of a given document (indicated in the column 305) and/or if the document contains mobile content in general (indicated in the column 306). The content classifier 82 is able to calculate a confidence rating upon completing its classification of a given document. The entries contained within the index 72 may be sorted based upon the confidence ratings listed in the column 310, such that the entries with higher confidence ratings are listed higher. The search engine 70 may also be able to use the confidence ratings to rank search results that are provided back to search request initiators, such as the mobile device 62 or the client computer 64.

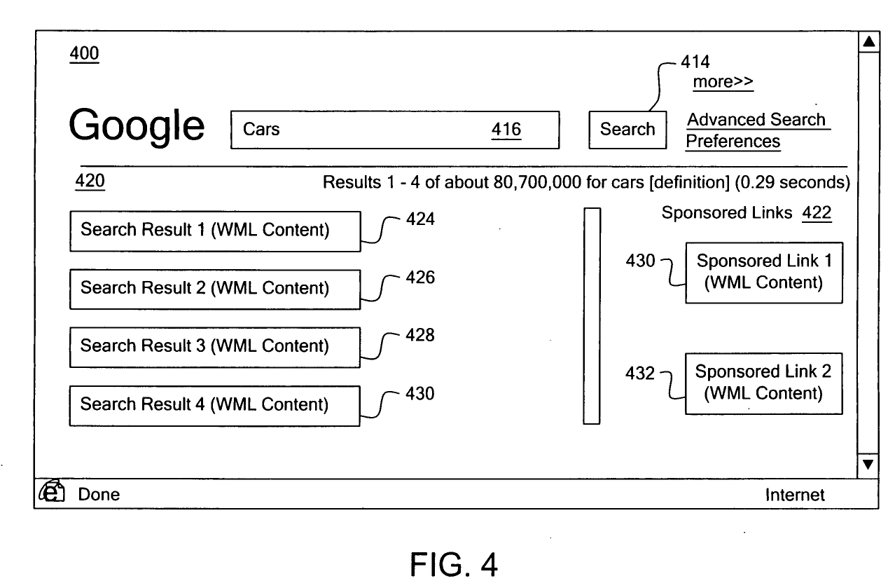

FIG. 4 is a screen diagram of a graphical user interface that may be provided to a user for searching electronic content within the system 100 shown in FIG. 1B, according to one implementation. The graphical user interface includes a window 400 that can be displayed to the user. For example, the window 400 may be displayed to the user on the mobile device 62 or the client computer 64. The information displayed within the window 400 is provided by the data processing system 50, according to one implementation.

If the user wishes to conduct a search of electronic content, the user may initiate a search request. For example, if the user is using the mobile device 62, the mobile device 62 may display the window 400 to the user. The user may enter one or more search terms, or keywords, within a text-entry field 416 and then select a button 414. Once the user does this, the mobile device 62 sends a search request to the data processing system 50. The search request includes the search terms entered by the user. The search engine 70 then searches for matching entries within the index 72.

In the example shown in FIG. 4, it is assumed that the user's computing device, such as the mobile device 62, is a device that supports WML (mobile) content. As such, the search engine 70 will search for entries that relate to the search request and that also are associated with electronic documents having mobile content. In one implementation, the search engine 700 will also look for entries associated with electronic documents having, specifically, WML content. The matching entries, or search results, are provided back to the user's device for display within a section 420 the window 400. As shown in the example of FIG. 4, there are four matching search results 424, 426, 428, and 430 included in the section 420. The user may select any of the results 424, 426, 428, or 430 to retrieve the corresponding documents from one or more of the servers 60 shown in FIG. 1B.

In one implementation, the data processing system 50 may further search for advertisement entries that correspond to advertisements from registered sponsors. The data processing system 50 searches for entries associated with advertisements having mobile content, or even specific WML content, according to some implementations. Matching entries are then provided to the user and displayed to the user within a section 422 of the window 400. As shown in the example of FIG. 4, two entries 430 and 432 are displayed to the user within the section 422.

In one implementation, the data processing system 50 may filter the results displayed in the sections 420 and 422 of the window 400 based upon the specific type of device that the user is using. For example, the data processing system 50 may be informed, or may be able to determine, that the user is using a “Brand X Model 1” type of mobile device. In this case, the search engine 70 may search for those entries in the index 72 associated with mobile content that can be displayed on this particular type of device. In one implementation, the search engine 70 may use a configuration parameter to determine whether to specifically filter search results based on the type of mobile device, or whether to more generally filter search results based only on the type of content (e.g., mobile WML content, mobile XHTML Basic content, etc.).

In one implementation, the results 424, 426, 428, and 430, or the results 430 and 432, may be ranked (e.g., top-down ranking) according to the confidence ratings associated with the result entries. (The column 310 shown in FIG. 3B includes examples of confidence ratings that may be associated with entries stored in the index 72.) If, for example, the search engine 70 is more confident that search results 424 and 426 include mobile (or WML) content than the results 428 and 430, it may specify that the results 424 and 426 should be ranked higher within section 420 than the results 428 and 430.

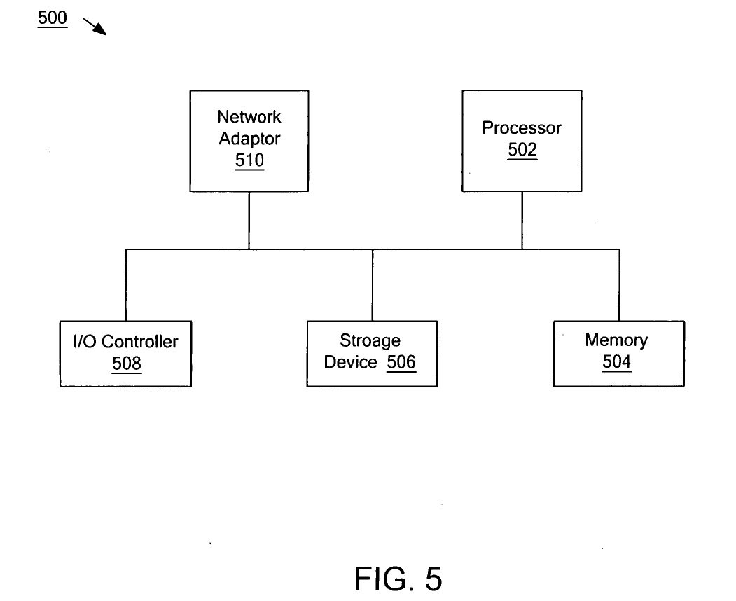

FIG. 5 is a block diagram of a computing device 500 that may be used within any components 50, 60, 62, or 64 shown in FIG. 1B, according to one implementation. The computing device 500 includes a processor 502, a memory 504, a storage device 506, an input/output controller 508, and a network adaptor 510. Each of the components 502, 504, 506, 508, and 510 are interconnected using a system bus. The processor 502 is capable of processing instructions for execution within the computing device 500. The processor 502 is capable of processing instructions stored in the memory 504 or on the storage device 506 to display graphical information for a GUI on an external input/output device that is coupled to the input/output controller 508. In other implementations, multiple processors and/or multiple buses may be used, as appropriate. Also, multiple computing devices 500 may be connected, with each device providing portions of the necessary operations.

The memory 504 stores information within the computing device 500. In one implementation, the memory 504 is a computer-readable medium. In one implementation, the memory 504 is a volatile memory unit. In another implementation, the memory 504 is a non-volatile memory unit.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device.

In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or a propagated signal.

The input/output controller 508 manages input/output operations for the computing device 500. In one implementation, the input/output controller 508 is coupled to an external input/output device, such as a keyboard, a pointing device, or a display unit that is capable of displaying various GUI's, such as the GUI shown in the FIG. 4, to a user.

The computing device 500 further includes the network adaptor 510. The computing device 500 uses the network adaptor 510 to communicate with other network devices.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of these implementations. Accordingly, other implementations are within the scope of the following claims.

What is claimed is:

1. A method for classifying electronic content, the method comprising:
obtaining an electronic document from a computing system;
identifying one or more document features of the electronic document;
analyzing the identified document features to determine a format of electronic content contained in the electronic document, the determined format being implied by one or more indicators provided by the identified document features; and
specifying whether the electronic content contained in the electronic document may be displayed on an identified type of computing device, based on the determined format.

2. The method of claim 1, wherein specifying whether the electronic content contained in the electronic document may be displayed on an identified type of computing device comprises analyzing content-based document features.

3. The method of claim 1, wherein the identified document features are analyzed by a machine learning system.

4. The method of claim 1, further comprising:
determining whether to insert an indexed entry associated with the electronic document into a searchable index based upon a level of confidence that the electronic content contained in the electronic document is displayable on the predetermined type of computing device.

5. The method of claim 4, wherein the indexed entry indicates the determined format of the electronic document.

6. The method of claim 1, wherein the electronic content contained in the electronic document comprises displayable web content.

7. The method of claim 1, wherein at least one document feature of the electronic document comprises a tagged feature that may be interpreted for display of electronic content on a computing device.

8. The method of claim 1, wherein analyzing the identified document features comprises applying a predetermined ruleset to the identified document features.

9. The method of claim 8, wherein the predetermined ruleset applies one or more decisions to a plurality of document features.

10. The method of claim 1, wherein specifying whether the electronic content contained in the electronic document may be displayed on an identified type of computing device comprises applying one or more heuristic rules to the determined format and the identified document features.

11. The method of claim 1, wherein specifying whether the electronic content contained in the electronic document may be displayed on an identified type of computing device comprises calculating a confidence rating that is based on a determined level of confidence that the electronic content contained in the electronic document is displayable on the identified type of computing device.

12. The method of claim 11, further comprising:
creating an indexed entry associated with the electronic document, the indexed entry indicating whether the electronic content contained in the electronic document may be displayed on the identified type of computing device; and
inserting the indexed entry into a searchable index, the indexed entry being ranked within the searchable index.

13. The method of claim 1, wherein the identified type of computing device comprises a computing device that is capable of displaying electronic content having one or more predetermined formats.

14. The method of claim 13, wherein the computing device comprises a wireless device.

15. The method of claim 1, wherein the identified type of computing device comprises a predetermined brand or model of computing device.

16. The method of claim 1, wherein the determined format is selected from a group consisting of an XHTML (Extensible Hypertext Markup Language) format, an HTML (Hypertext Markup Language) format, a WML (Wireless Markup Language) format, and a cHTML (compact HTML) format.

17. A computer program product tangibly embodied in an information carrier, the computer program product including instructions that, when executed, perform a method for classifying electronic content, the method comprising:
obtaining an electronic document that is stored in a computing system, the electronic document having electronic content;
parsing the electronic document and identifying one or more document features of the electronic document;
analyzing the identified document features to determine a format of the electronic content contained in the electronic document, the determined format being based upon one or more indicators provided by the identified document features; and
based upon the determined format and the identified document features, specifying whether the electronic content contained in the electronic document may be displayed on a predetermined type of computing device.

18. A system for classifying electronic content, the system comprising:
means for receiving an electronic document;
means for determining a format of electronic content contained in the electronic document; and
means for specifying whether the electronic content contained in the electronic document may be displayed on a predetermined type of computing device based upon the determined format.

19. A method for classifying electronic content, the method comprising:
obtaining an electronic document from a computing system;
identifying a document type for the document using an explicit document type identifier associated with the document;
analyzing one or more document features and the identified document type to determine a format of electronic content contained in the electronic document, the determined format being implied by one or more indicators provided by the identified document features; and
based upon the determined format, specifying whether the electronic content contained in the electronic document may be displayed on an identified type of computing device.

20. A method for classifying electronic content, the method comprising:
obtaining from a computing system an electronic document having electronic content;
identifying a plurality of document features of the electronic document;
calculating a document score based on the plurality of document features; and
specifying whether the electronic content contained in the electronic document may be displayed on an identified type of computing device, based on the document score.

21. The method of claim 20, wherein the document features comprise implied document features.

22. The method of claim 21, wherein the document features comprise content-based document features.
